(19) United States
(12) Patent Application Publication
(10) Pub. No.: US 2012/0078718 A1
(43) Pub. Date: Mar. 29, 2012

(54) COMMUNICATIONS SYSTEM FOR GENERATING RECOMMENDATIONS AND RELATED METHODS

(75) Inventors: Anand Ravindra Oka, Waterloo (CA); Christopher Harris Snow, Kitchener (CA); Sean Bartholomew Simmons, Waterloo (CA)

(73) Assignee: Research In Motion Limited, Waterloo (CA)

(21) Appl. No.: 13/223,721

(22) Filed: Sep. 1, 2011

Related U.S. Application Data
(60) Provisional application No. 61/386,904, filed on Sep. 27, 2010.

(51) Int. Cl. G06Q 30/02

(52) U.S. Cl. 705/14.53

(57) ABSTRACT

A communications system may include an electronic device associated with a given user, and a communications network. The communications system may also include a modeling server configured to communicate with the electronic device via the communications network. The modeling server may also be configured to generate a purchase probability distribution using a statistical model based upon prior purchase information for the given user and prior purchase information for a plurality of other users. The modeling server may also be configured to determine new purchase recommendations for the given user using the purchase probability distribution, and provide the new purchase recommendations to the electronic device.

### RELATED APPLICATION

This application is based upon previously filed copending provisional application Ser. No. 61/386,904 filed Sep. 27, 2010, the entire subject matter of which is incorporated herein by reference in its entirety.

### TECHNICAL FIELD

The present disclosure relates to the field of communications, and, more particularly, to statistical recommendation systems and related methods.

### BACKGROUND

A “top ten” recommendation list is relatively popular. For example, the top ten best-selling books, the top ten downloaded songs, the top ten downloaded applications, and the top ten news stories. An expurgated top ten list, which drops the previous purchases/downloads of a user from the list, may provide increasingly effective recommendations while being relatively simple.

However, collaborative filtering (CF) may be a dominantly popular recommendation technique that makes increasingly sophisticated use of prior purchase history of users of a marketplace. A standard CF methodology is linear algebraic, and is generally based upon a singular value decomposition (principal component analysis) of the purchase data.

### BRIEF DESCRIPTION OF THE DRAWINGS

FIG. 1 is a schematic diagram of a system in accordance with an example embodiment.

FIG. 2 is a table of users and items that may be stored in the database of the system of FIG. 1.

FIG. 3 is a flow chart of a distributed implementation of model identification in accordance with an example embodiment of the present invention.

FIGS. 4a-4c are performance comparison graphs using different statistical models for a given user with greater than 8 purchases.

FIGS. 5a-5c are performance comparison graphs using different statistical models for a given user with greater than 16 purchases.

FIGS. 6a-6c are performance comparison graphs using different statistical models for a given user with greater than 24 purchases.

FIG. 7 is a schematic block diagram illustrating additional components that may be included in the mobile wireless communications device of FIG. 1

### DETAILED DESCRIPTION OF THE PREFERRED EMBODIMENTS

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Like numbers refer to like elements throughout.

In accordance with an example aspect, a communications system may include an electronic device associated with a given user, and a communications network, for example. The communications system may also include a modeling server configured to communicate with the electronic device via the communications network. The modeling server may also be configured to generate a purchase probability distribution using a statistical model based upon prior purchase information for the given user and prior purchase information for a plurality of other users, for example. The modeling server may also be configured to determine new purchase recommendations for the given user using the purchase probability distribution, and provide the new purchase recommendations to the electronic device. Accordingly, the communications system may provide more relevant new purchase recommendations to the given user.

The modeling server may include a plurality of parallel processors configured generate the purchase probability distribution using a statistical model, for example. The statistical model may include a statistical model having a factor order greater than or equal to two. In other words, the statistical model may have basis functions, i.e. factors, having a factor order greater than or equal to two, for example.

The modeling server may be configured to generate the purchase probability distribution based upon a Boltzmann model (i.e. Markov Random Field), for example. The modeling server may also be configured to generate the purchase probability distribution based upon an unrestricted Boltzmann model. In other words, a connectivity graph of the Boltzmann model may be unrestricted, and may include pair-wise interaction factors and higher order interaction factors.

The modeling server may be configured to retrieve prior purchase information for the given user as a random realization. The modeling server may also include a database configured to store the prior purchase information for the given user and the prior purchase information for a plurality of other users, for example.

The communications network may include a cellular communications network, for example. The electronic device may include a mobile wireless communications device, for example.

A method aspect is directed to a method of providing new purchase recommendations for a given user associated with an electronic device. The method may include using a modeling server configured to communicate with the electronic device via a communications network to at least generate a purchase probability distribution using a statistical model based upon prior purchase information for the given user and prior purchase information for a plurality of other users, and determine new purchase recommendations for the given user using the purchase probability distribution. The modeling server may further be used to provide the new purchase recommendations to the electronic device. Additionally, the functionality of the modeling server may be included as computer executable instructions included on a non-transitory computer-readable medium.

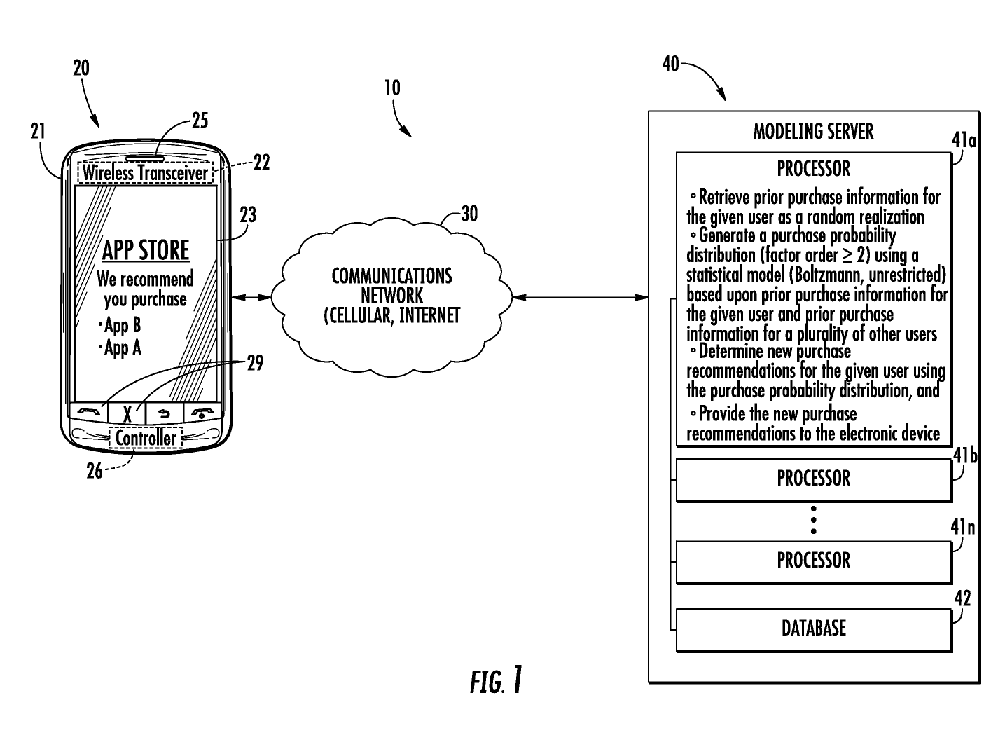

Referring initially to FIG. 1, a communications system 10 includes an electronic device 20 associated with a given user. The electronic device 20 illustratively is a mobile wireless communications device, such as, for example, a cellular telephone.

The mobile wireless communications device 20 illustratively includes a housing 21, a wireless transceiver 22 carried by the housing, and a display 23 carried by the housing. The mobile wireless communications device 20 also illustratively includes an audio transducer carried by the housing 21. The audio transducer 25 may be a microphone, for example. The audio transducer 25 may also be a speaker. In some example embodiments, there may be more than one audio transducer 25, for example, a microphone and speaker may be used and carried by the housing 21.

The mobile wireless communications device 20 includes one or more input devices 29. The input devices 29 illustratively include push buttons for cooperating with a controller 26 to selectively enable the speech conversion and proposed modification determination. In some example embodiments, the input device 29 may be an alphanumeric keypad or other input device for cooperating with the controller 26, for example. Still further, an input device 29 may be coupled to the display 23 to accept a touching input therefrom, for example.

The controller 26 is also carried by the housing 21 and cooperates with the wireless transceiver 22 to perform at least one mobile wireless communications function. For example, the wireless transceiver 22 may be a cellular transceiver or a WiFi transceiver, for example, and may cooperate with the controller 26 to communicate data and/or voice communications. Other types of wireless transceivers and mobile wireless communications functions will be appreciated by those skilled in the art. The electronic device 20 may be another type of electronic device, for example, a personal computer (PC), which may be a shared or public PC, a personal digital assistant (PDA), a tablet PC, or other communications device, either shared or personal, and wired or wireless, as will be appreciated by those skilled in the art.

The communications system 10 also includes a communications network 30. The communications network 30 may be wireless communications network, for example, a cellular communications network. The communications network 30 may be another type network, for example, an 802.11x network, or the Internet. The communications network 30 may also be a combination of networks, including, for example, wired and wireless networks.

The communications system 10 illustratively includes a modeling server 40. The modeling server includes multiple processors 41a-41n, or controllers, coupled in parallel. In some embodiments, the processors 41a-41n may not be coupled in parallel, or the modeling server 40 may include a single processor. The modeling server 40, by way of the processors 41a-41n, is configured to communicate with the electronic device 20 via the communications network 30. As will be appreciated by those skilled in the art, the modeling server 40 may not communicate directly with the electronic device 20, but may communicate through one or more communications or proxy servers (not shown). For example the electronic device 20 may be a PC and connect to the modeling server 40 over the Internet via a web browser.

The modeling server 40 may be particularly advantageous for recommending new purchases at an online store, such as, for example, an online application store for the electronic device 20. In particular, for example, as a statistical average over all users, a “top ten” recommendation list generally does not attempt to personalize a new purchase recommendation list for a given user. The modeling server 40 advantageously may recommend the “top ten” items in popularity after expurgating the items that the given user has already bought/seen, based upon a history of each user's prior purchases.

The modeling server 40 includes a database 42 that may store the prior purchase information for users. Additional information may be stored in the database 42, as will be appreciated by those skilled in the art.

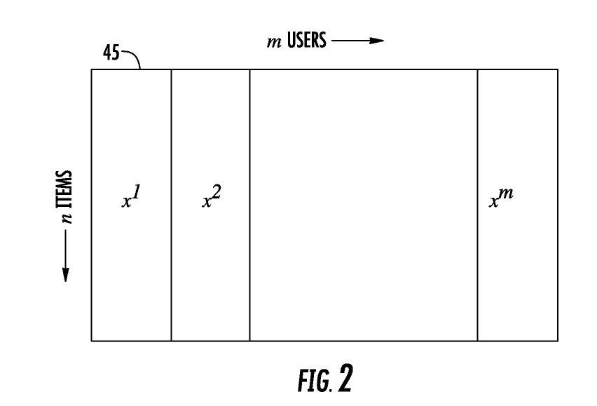

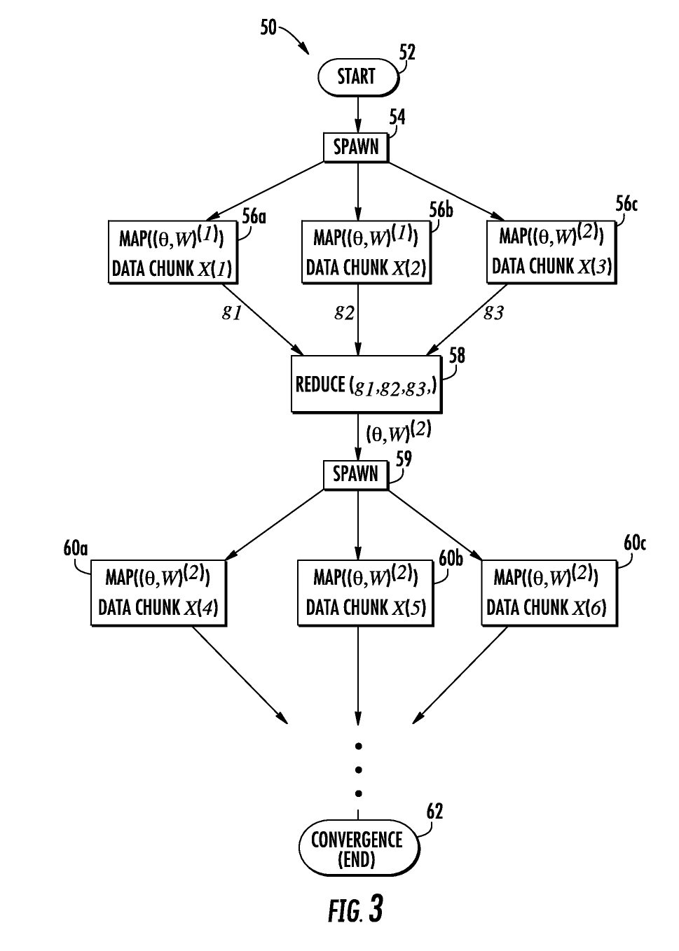

The functionality of the modeling server 40 will be described in further detail with references to FIGS. 2-3. Moreover, the functionality of the modeling server 40 may be shared among a plurality of servers (not shown).

The modeling server 40 is configured to generate a purchase probability distribution using a statistical model based upon prior purchase information for the given user and prior purchase information for other users. For example, referring to table 45, a total of m users and n items may be in a marketplace, or in an online or application store (FIG. 2). For example, m=50 million, and n=13,000, and hence n<<m. Indeed, data may be considered where n>>m. An n×m matrix X includes entries from the set {+1, −1} and indicate user purchases. Thus, Xᵢⱼ=+1 indicates that user j, j=1, 2, . . . , m has previously purchased the item i, i=1, 2, . . . , n. Xᵢⱼ=−1 indicates otherwise.

Non-binary values may not be included in the matrix X, as this may cause the math to breakdown. Accordingly, a separate data structure or matrix R of the same dimensions as X may include reviews or “likes” of users for various items. The “likes” may be expressed as a real number where a relatively large positive value indicates a relatively strong liking, and a relatively large negative value indicates a relatively strong dislike. The matrix R may be used as a bias. As will be appreciated by those skilled in the art, a user may like an item, but may not have purchased that item. Moreover, data in the matrix X increases with time by adding new users (more columns) and new items (more rows) to the table 45 and consequently, the database 42.

Given the data in matrix X and a particular purchase history x, which may or may not be a column of X, the modeling server 40 may advantageously deliver a list of L recommendations (i.e. a list of L item indices) based upon a prior purchase history x that may increasingly “fit” the prior purchase history of the given user.

The modeling server 40 advantageously considers each user's purchase history as a realization from a binary valued Markov Random Field, known as a Boltzmann model (a.k.a. an Ising model). In such models, the probability of a purchase realization, or a purchase of a particular product or service, is exponential with respect to an energy function of that purchase realization.

The Boltzmann Model, which is an instance of a Markov Random Field, is initially used. The columns of X are modeled as vectors drawn from {+1, −1}ⁿ, according to an exponential distribution:

Q(x|γ)=exp{γ^{T}f(x)−Ψ(γ)} (1)

Where γεR^{b} is a parameter, and f: {+1, −1}ⁿ→{+1, −1}^{b} is a column vector of basis functions. The constant term Ψ(γ) in the exponent is for normalization and is independent of x. The vectors may be modeled to be drawn identically and independently from {+1, −1}ⁿ.

The quantity Ψ(γ)−θ^{T}x−θ^{T}x−½x^{T}Wx is viewed as the “energy” of configuration x, so configurations with a larger energy generally have a smaller probability. For example, the Boltzmann Model with linear and quadratic basis functions may be used as follows:

Q(x|θ,W)=exp{θ^{T}x+½x^{T}Wx−Ψ(θ,W)} (2)

Where θεRⁿ, and WεR^{n×n} symmetric with zero diagonal entries are the parameters of this model.

A first step is choosing a structure of the model based upon which basis functions to use. For example, the basis functions are initially restricted to linear and quadratic basis functions. W is a relatively very large matrix of about 10⁸ entries, and it may not be practical to work with so many parameters. Accordingly, W may be masked in some way. For example, an approach is to select a sparse mask M for W. That is, W is allowed to have only O(N) non-zero entries, at randomly chosen locations. Moreover, it may be particularly advantageous to choose the mask M with a more structured randomness. In particular, when choosing the non-zero locations, priority may be given to locations that involve popular items (e.g. items in the online stores, or applications in an application store). The popularity ratings of the items may be pre-computed. This may result increased average recommendation performance.

However, the above approach may also lead to “islands of disconnect” involving unpopular items. In other words, relatively unpopular items may not get recommended well by the model. This may not affect the average performance as much, but may cause inadequate performance when recommending for the “long tail” scenario, i.e. users who have a long purchase history and are now looking for the odd “off-beat” item that may be purchased by relatively few other people.

To address this problem, higher order basis functions may also be included. A higher order basis function may include a factor order greater than two, such as, for example, cubic, quaternary, etc. By including a relatively small number of such high order basis functions, the connectivity of the graph may be improved, and the “islands of disconnect” may be reduced. This may increase performance in an increased number of scenarios.

Additionally, higher order basis functions may also allow for the reduction of the total number of parameters, b, to be estimated, which, in turn, may further improve performance by reducing the load on the processors 41a-41n.

The second task is to estimate the model parameters. For clarity, the example of a model with linear and quadratic basis functions will be considered, while noting that the description applies equally to models with higher order basis functions.

The estimation of the parameter γ=(θ, W) may be performed by iterating the following two steps of the incremental-EM algorithm until convergence, where each iteration processes one column x of X:

θ←θ+ε(x−E[Z|θ,W]) (3)

W←W+εMo(xx^{T}−E[ZZ^{T}|θ,W]) (4)

where Z is a placeholder, E[·|θ, W] denotes an expectation under the model Q(x|θ, W), and ε a suitable small step-size. Indeed, it may be infeasible to calculate the expectations E[·|θ, W], since it may be an exponentially difficult problem in terms of n.

Instead, a Gibbs-Sampling approximation approach may be used. In other words, a Markov-Chain Monte Carlo (MCMC) may be configured whose stationary distribution is Q(x|θ, W), and then perform transitions of this chain to thus obtain a sufficiently large sample set. Empirical averages may be performed over the sample set. For improved accuracy estimates of the expectation, a relatively large sample set may be desired, which may lead to increased computational complexity.

However, when there is an increased amount of data (i.e. X has a very large number of columns), matters may be simplified by using one MCMC sample, making one transition per column and using this as the estimate of the mean. This sample may be retained as the initial state for making the MCMC draw in the next iteration of the estimator, and so on. Since ε is relatively small, the parameter may not change much during the processing of a large number of columns of X, and thus, an increased amount of samples may be drawn from the MCMC of approximately the same distribution. Such algorithms may be referred to as doubly stochastic. Thus, the following resulting algorithm may be iterated over the successive columns x of X, starting from some initial state αε {+1, −1}ⁿ:

θ←θ+Wα (5)

α←Bernoulli (exp(̂θ)/(exp(̂θ)+exp(−̂θ))) (6)

θ←θ+ε(x−α) (7)

W←W+εMo(xx^{T}−αα^{T}) (8)

where Bernoulli (p) is a random vector in {+1, −1}ⁿ whose elements are drawn independently with Pr (+1) given by vector p.

Given a user preference vector x, which may be a column from X or may be a new user, for example, and given the estimated parameters θ, W, x may be completed by moving it to a local maxima of the probability measure Q(x|θ, W). Based upon Gibbs Sampling, this may be achieved by:

r=θ+Wx (9)

Where r represents the a-posteriori log-probability of purchase of items by the given user. The list of L recommendations may then be obtained by sorting r in a descending order and selecting indices corresponding to the top L entries, the new purchase recommendations for the given user.

In other words, the modeling server 40 determines new purchase recommendations for the given user using the purchase probability distribution. It should be noted that the new purchase recommendations account for the popularity of individual items via the bias 8, and the inter-dependencies between the various items via W. A somewhat more elaborate recommendation technique may include computing the following “mean-field” recursion until convergence, starting from the initial condition r=0:

r←tan h(θ+α+Wr) (10)

where αᵢ=L when xᵢ=+1, and αᵢ=0 where L is a relatively large number, for example, L=100. The mean-field technique may give a relatively small improvement over the technique described above with respect to equation (9), and thus may be considered optional.

The modeling server 40 is also configured to provide the new purchase recommendations to the electronic device 20. For example, the modeling server 40 may send the new purchase recommendations to the electronic device based upon a request from the electronic device. The modeling sever 40 may also send the new purchase recommendations as an email to an email account associated with a given user, the email of which may be retrieved by the electronic device 20. The modeling server 40 may send the new purchase recommendations in other formats, such as, for example, a short messaging service (SMS) message. The new purchase recommendations may be displayed on the display 13 of the mobile wireless communications device 20.

Using the Boltzmann model for identification may use an increased amount of resources in the modeling server 40. This is because an unrestricted Boltzmann model advantageously allows for any factor may be mapped to any variable. Accordingly, it may take the modeling server 40 a relatively longer time period to perform calculations based upon the increased resource usage. Thus, it may be desirable for the modeling server 40 to perform the calculations in a relatively short amount of time. For example, in a relatively large number scenario, it may be increasingly difficult to perform the calculations in a reasonable time period on a single workstation (i.e. a single processor, controller, or computer).

Thus, the calculations, or model identification procedure, may be executed on multiple parallel processors 41a-41n. This may advantageously distribute the processing load among each of the processors 41a-41n.

Referring now to the flowchart 50 FIG. 3, starting at Block 52, a distributed implementation of the model identification procedure on a cluster using the MAP-Reduce Schema may be used. Recall that in equations (6-8), the gradient calculation

̂θ←θ+Wα

α←Bernoulli (exp(̂θ)/(exp(̂θ)+exp(−̂θ)))

g_{θ}=(x−θ)

g_{w}=Mo(xx^{T}−αα^{T})

is made for each input column, and the gradient g=(gθ, gW) is used to update the parameters θ, W. A sufficient amount of averaging may be achieved by using a small enough C.

However, alternatively, the gradient g may be averaged over several columns (without updating θ, W), and then making a single update of θ, W. Since the calculation of the average gradient without updates is a “stateless” calculation, it may be made into parallel MAP operations. As will be appreciated by those skilled in the art, each MAP module may maintain an internal state a from processing one column to the next out of its data chunk, but this state variable is distinct for every MAP module, so there may be no cross communication among the maps, as is typically required by the MAP-REDUCE paradigm. Thus the data matrix X may be partitioned, or spawn, into chunks X(1), X(2), X(3), X(4), . . . X(n) at Block 54. Of these chunks, a number may be chosen for use, for example, three, at a time. Three parallel MAP processes, each given a parameter (θ, W), calculate their own average value of the gradient over the data chunks X(1), X(2), and X(3), respectively (Block 56). The gradient values g1, g2, g3 are then gathered at Block 58 by the REDUCE step which combines the gradients to get g=⅓Σ³ᵢ₌₁ gᵢ, and then updates the Boltzmann parameters once to obtain:

θ←θ+εgθ

W←W+εgW

This new value (θ, W)⁽²⁾ may now be used to spawn (Block 59) a new set of three MAP process that work on the next three chunks X(4), X(5), and X(6), respectively, at Block 60, and the procedure is repeated. The MAP-REDUCE iteration is continued until convergence is achieved at Block 62. As before, convergence may occur before all chunks are consumed. In the case where convergence does not happen before all chunks are consumed, the chunks may be recycled.

In particular, the ε used in the MAP-REDUCE scheme above may be much larger than the value used in the column-by-column update of equations 6-8, since a relatively considerable amount of averaging has already been performed in each MAP step and the REDUCE step. Hence the number of MAP-REDUCE iterations may be less than those in the original algorithm, and, moreover, a relatively increased reduction in running time may be obtained, provided the individual MAP steps can run on independent processors 41a-41n.

As will be appreciated by those skilled in the art, newly arriving data may be incorporated into the model in an online fashion, or sequentially. For example, new purchase data may arrive everyday in the form of extra columns of X. A Hadoop based incremental estimation algorithm may be performed on additional data until convergence. This may have beneficial effects. For example, the daily procedure may have a relatively moderate load since the incremental data may be relatively small, and the convergence may occur relatively quickly because the model may changes marginally in a one day. Additionally, the effect of older data is deprecated, which may be particularly advantageous to track recent buying trends. As will be appreciated by those skilled the art, while a Hadoop based incremental estimation method is performed, other incremental estimation methods may be used and may be performed on other distributed processing platforms.

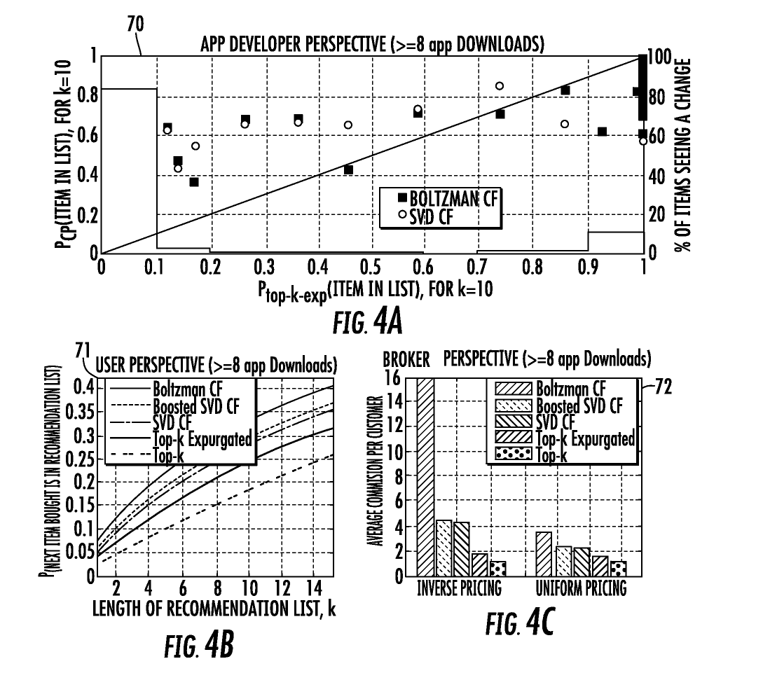

Referring now to the graphs in FIGS. 4a-6c, a comparison of the performance of the various collaborative filtering schemes is illustrated. For comparison, data for application downloads from an online application store for the electronic device 20 is used. The performance metric is the probability P that, in the presented list of L recommendations, the next item bought by the given user is included. For calculating this probability, for each user, one of the items the given user has bought is randomly chosen and removed from his purchase list. The modeling server 40 may then use this modified purchase vector and provide a list of recommendations of length L, and check if the list includes the previously removed item.

The frequency of this event is the estimate of the desired probability. The probability calculation is based upon users of who have made at least p purchases, when p is a parameter that may be chosen. It may be expected that the advantages of the various variants of CF over top-K will be relatively significant as p is made relatively large (i.e. considering users with a sufficiently long download history). In particular, the graphs 70, 71, and 72, respectively illustrate comparative performance for from an application developer's perspective (FIG. 4a), a user's perspective (FIG. 4b), and an application broker or agent's perspective (FIG. 4c). The graphs 70, 71, and 72 are based upon a given user who has made at least 8 purchases.

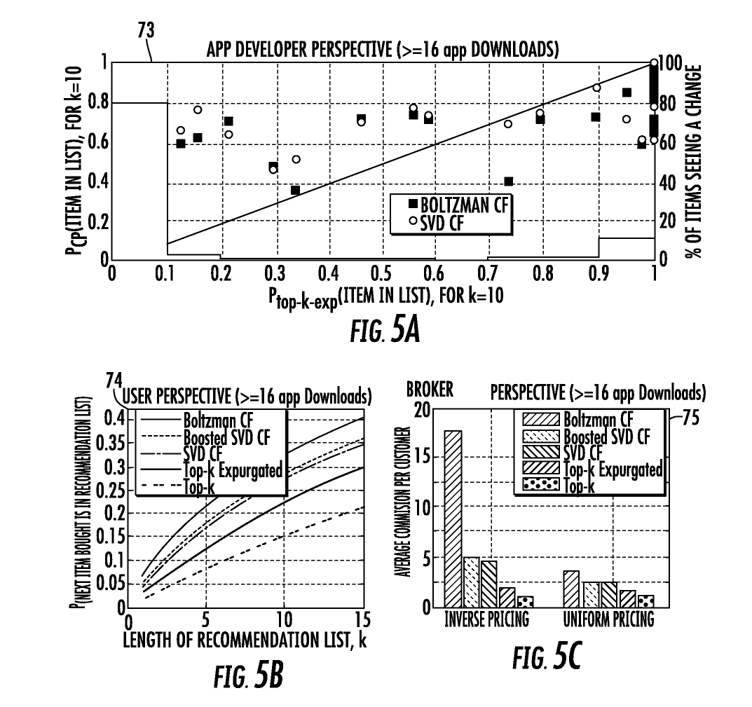

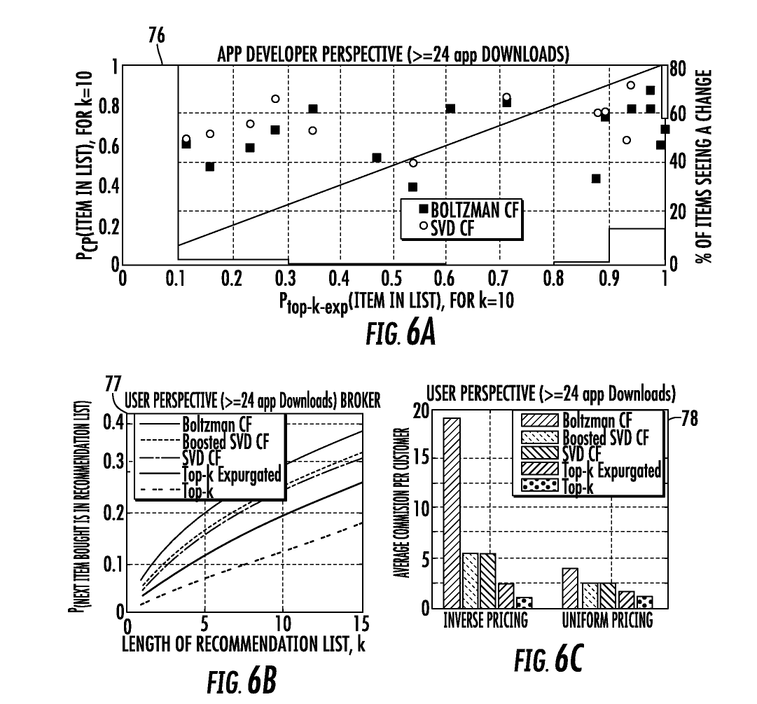

The graphs 73, 74, and 75, respectively illustrate comparative performance for from an application developer's perspective (FIG. 5a), a user's perspective (FIG. 5b), and an application broker or agent's perspective (FIG. 5c) based upon a given user who has made at least 16 purchases. The graphs 76, 77, and 78 in FIGS. 6a, 6b, and 6c, respectively, illustrate performance based upon a given user who has made at least 24 purchases.

From the graphs in FIGS. 4-6, the main conclusions that may be drawn include, assuming a recommendation list of length 10, expurgated top-k gives a about a 30% improvement over basic top-k. Singular value decomposition (SVD) CF gives another 20% improvement over expurgated top-k, which amounts to a 70% improvement over basic top-k.

Boosted SVD CF gives a relatively small improvement, in particular, 6%, over SVD CF. However, this may be because the quality of “content” available on the applications in the form of descriptions and reviews is generally not particularly detailed. Performance may improve when content becomes more relevant. For example, user data, i.e. data available to describe the users, may not be available, and having such data to use in processing may also improve performance.

The Boltzmann CF has a relatively sizeable improvement of 20% over SVD CF, and 110% improvement over basic top-k. The improvements in terms of average broker revenue per customer are even more sizeable than from the user perspective (FIGS. 4c, 5c, and 6c). Similarly, from an application developer perspective, many applications that may rarely be recommended under top-k and expurgated top-k, for example, may be recommended an increased amount of times under the collaborative filters. Conversely, a relatively smaller number of popular applications may lose a so visibility, or recommendations. However, overall, there may be an average net improvement. Moreover, popular applications typically do not lose much ranking in terms of download probability even if they do not appear in the recommendation list, because they already are, by definition, quite well known among the user community.

A method aspect is directed to a method of providing new purchase recommendations for a given user associated with an electronic device 20. The method includes using a modeling server 40 configured to communicate with the electronic device 20 via a communications network 30 to generate a purchase probability distribution using a statistical model based upon prior purchase information for the given user and prior purchase information for a plurality of other users. The method also includes using the modeling server 40 to determine the new purchase recommendations for the given user using the purchase probability distribution. The method also includes using the modeling server 40 to provide the new purchase recommendations to the electronic device 20.

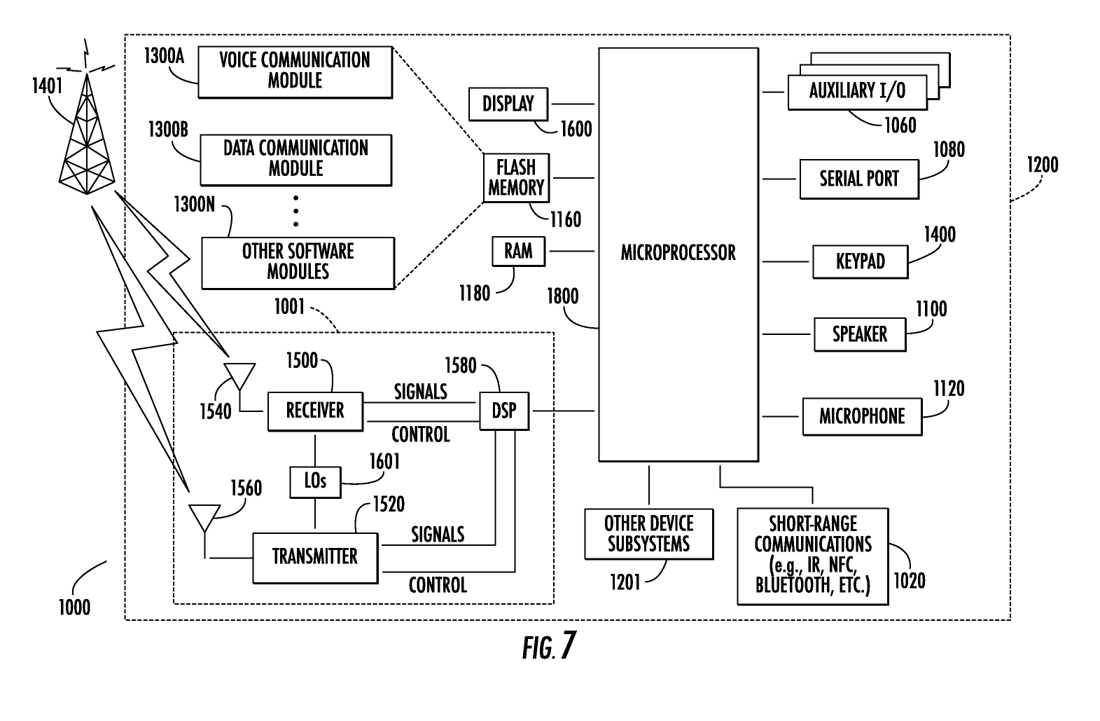

Exemplary components that may be used in various embodiments of the above-described electronic device 20 are now described with reference to an exemplary mobile wireless communications device 1000 shown in FIG. 7. The device 1000 illustratively includes a housing 1200, a keypad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user. In some embodiments, keypad 1400 may comprise a physical keypad or a virtual keypad (e.g., using a touch-sensitive interface) or both.

The housing 1200 may be elongated vertically, or may take on other sizes and shapes (including clamshell housing structures, for example). The keypad 1400 may include a mode selection key, or other hardware or software for switching between text entry and telephony entry.

In addition to the processing device 1800, other parts of the mobile device 1000 are shown schematically in FIG. 7. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having voice and data communications capabilities. In addition, the mobile device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications or modules 1300A-1300N on the device 1000, such as software modules for performing various steps or operations. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem 1020 may include an infrared device and associated circuits and components, near-field communication (NFC), or a Bluetooth™ communications module to provide for communication with similarly-enabled systems and devices.

Many modifications and other example embodiments of the present disclose will come to the mind of one skilled in the art having the benefit of the teachings presented in the foregoing descriptions and the associated drawings. Therefore, it is understood that the present disclosure is not to be limited to the specific example embodiments disclosed, and that modifications and example embodiments are intended to be included within the scope of the appended claims.

That which is claimed is:

1. A communications system comprising:
an electronic device associated with a given user;
a communications network; and
a modeling server configured to communicate with said electronic device via said communications network, said modeling server also configured to
generate a purchase probability distribution using a statistical model based upon prior purchase information for the given user and prior purchase information for a plurality of other users,
determine new purchase recommendations for the given user using the purchase probability distribution, and
provide the new purchase recommendations to said electronic device.

2. The communications system of claim 1, wherein said modeling server comprises a plurality of parallel processors configured to generate a purchase probability distribution using a statistical model.

3. The communications system of claim 1, wherein the statistical model comprises a statistical model having a factor order greater than or equal to two.

4. The communications system of claim 1, wherein said modeling server is configured to generate the purchase probability distribution based upon a Boltzmann model.

5. The communications system of claim 4, wherein said modeling server is configured to generate the purchase probability distribution based upon an unrestricted Boltzmann model.

6. The communications system of claim 1, wherein said modeling server is configured to retrieve prior purchase information for the given user as a random realization.

7. The communications system of claim 1, wherein said modeling server comprises a database configured to store the prior purchase information for the given user and the prior purchase information for a plurality of other users.

8. The communications system of claim 1, wherein said communications network comprises a cellular communications network.

9. The communications system of claim 1, wherein said electronic device comprises a mobile wireless communications device.

10. A modeling server configured to communicate with an electronic device associated with a given user via a communications network, the modeling server comprising:
at least one processor configured to
generate a purchase probability distribution using a statistical model based upon prior purchase information for the given user and prior purchase information for a plurality of other users,
determine new purchase recommendations for the given user using the purchase probability distribution, and
provide the new purchase recommendations to said electronic device.

11. The modeling server of claim 10, wherein said at least one processor comprises a plurality of parallel processors.

12. The modeling server of claim 10, wherein the statistical model comprises a statistical model having a factor order greater than or equal to two.

13. The modeling server of claim 10, wherein said at least one processor is configured to generate the purchase probability distribution based upon a Boltzmann model.

14. The modeling server of claim 10, wherein said at least one processor is configured to retrieve prior purchase information for the given user as a random realization.

15. The modeling server of claim 10, further comprising a database coupled to said at least one processor and configured to store the prior purchase information for the given user and the prior purchase information for a plurality of other users.

16. A method of providing new purchase recommendations for a given user associated with an electronic device comprising:
using a modeling server configured to communicate with the electronic device via a communications network to at least
generate a purchase probability distribution using a statistical model based upon prior purchase information for the given user and prior purchase information for a plurality of other users,
determine new purchase recommendations for the given user using the purchase probability distribution, and
provide the new purchase recommendations to the electronic device.

17. The method of claim 16, wherein using the modeling server comprises using a plurality of parallel processors configured to generate a purchase probability distribution using a statistical model.

18. The method of claim 16, wherein the statistical model comprises a statistical model having a factor order greater than or equal to two.

19. The method of claim 16, wherein the modeling server generates the purchase probability distribution based upon a Boltzmann model.

20. The method of claim 16, wherein the modeling server retrieves prior purchase information for the given user as a random realization.

21. A non-transitory computer-readable medium for use with a modeling server providing new purchase recommendations for a given user associated with an electronic device, and having computer-executable instructions for causing the modeling server to perform the steps comprising:
generating a purchase probability distribution using a statistical model based upon prior purchase information for the given user and prior purchase information for a plurality of other users;
determining new purchase recommendations for the given user using the purchase probability distribution; and
providing the new purchase recommendations to the electronic device via a communications network.

22. The non-transitory computer-readable medium of claim 21, wherein the computer-executable instructions are for causing the modeling server use a plurality of parallel processors configured to generate a purchase probability distribution using a statistical model.

23. The non-transitory computer-readable medium of claim 21, wherein the statistical model comprises a statistical model having a factor order greater than or equal to two.

24. The non-transitory computer-readable medium of claim 21, wherein the computer-executable instructions are for causing the modeling server to generate the purchase probability distribution based upon a Boltzmann model.

25. The non-transitory computer-readable medium of claim 21, wherein the computer-executable instructions are for causing the modeling server to retrieve prior purchase information for the given user as a random realization.
